(19) United States
(12) Patent Application Publication
(10) Pub. No.: US 2009/0094219 A1
(43) Pub. Date: Apr. 9, 2009

(54) METHOD AND SYSTEM FOR IDENTIFYING A CANDIDATE FOR AN OPPORTUNITY

(75) Inventor: Marcus M. Davis, Austin, TX (US)

Correspondence Address: DAVIS LAW GROUP, P.C., 6836 BEE CAVES ROAD, SUITE 220, AUSTIN, TX, 78746, US

(73) Assignee: HIRESTARTER, INC., Austin, TX (US)

(21) Appl. No.: 11/866,844

(22) Filed: Oct. 3, 2007

(51) Int. Cl. G06F 17/30

(52) U.S. Cl. 707/5; 707/E17.014

(57) ABSTRACT

A database stores information about persons and their qualifications. In response to information about a current opportunity that specifies at least one qualification, the database is searched to identify at least one of the following: first persons having qualifications that substantially match the current opportunity's specified qualification; and preexisting opportunities that specify one or more qualifications that substantially match the current opportunity's specified qualification. Also, the database is searched to identify target companies that satisfy at least one of the following conditions: the target company is where at least one of the first persons exists; the target company is where at least one of the first persons previously existed; the target company is where at least one of the preexisting opportunities exists; and the target company is where at least one of the preexisting opportunities previously existed. Further the database is searched to identify second persons that satisfy at least one of the following conditions: the second person exists in at least one of the target companies; and the second person previously existed in at least one of the target companies. A list of the second persons is output to a human user, so that the human user is equipped to contact the second persons.

### TECHNICAL FIELD

The disclosures herein relate in general to computer systems, and in particular to a method and system for identifying a candidate for an opportunity.

### SUMMARY

A database stores information about persons and their qualifications. In response to information about a current opportunity that specifies at least one qualification, the database is searched to identify at least one of the following: first persons having qualifications that substantially match the current opportunity's specified qualification; and preexisting opportunities that specify one or more qualifications that substantially match the current opportunity's specified qualification. Also, the database is searched to identify target companies that satisfy at least one of the following conditions: the target company is where at least one of the first persons exists; the target company is where at least one of the first persons previously existed; the target company is where at least one of the preexisting opportunities exists; and the target company is where at least one of the preexisting opportunities previously existed. Further the database is searched to identify second persons that satisfy at least one of the following conditions: the second person exists in at least one of the target companies; and the second person previously existed in at least one of the target companies. A list of the second persons is output to a human user, so that the human user is equipped to contact the second persons.

### BRIEF DESCRIPTION OF THE DRAWING

FIG. 1 is a block diagram of an information handling system, according to the illustrative embodiment.

FIG. 2 is a first entity-relationship diagram of a database that is automatically stored and managed by the system of FIG. 1, according to the illustrative embodiment.

FIG. 3 is a second entity-relationship diagram of the database that is automatically stored and managed by the system of FIG. 1, according to the illustrative embodiment.

FIG. 4 is a data flow diagram of a method that is automatically performed by the system of FIG. 1, according to the illustrative embodiment.

FIG. 5 is a process flow diagram of a method that is automatically performed by the system of FIG. 1, according to the illustrative embodiment.

### DETAILED DESCRIPTION

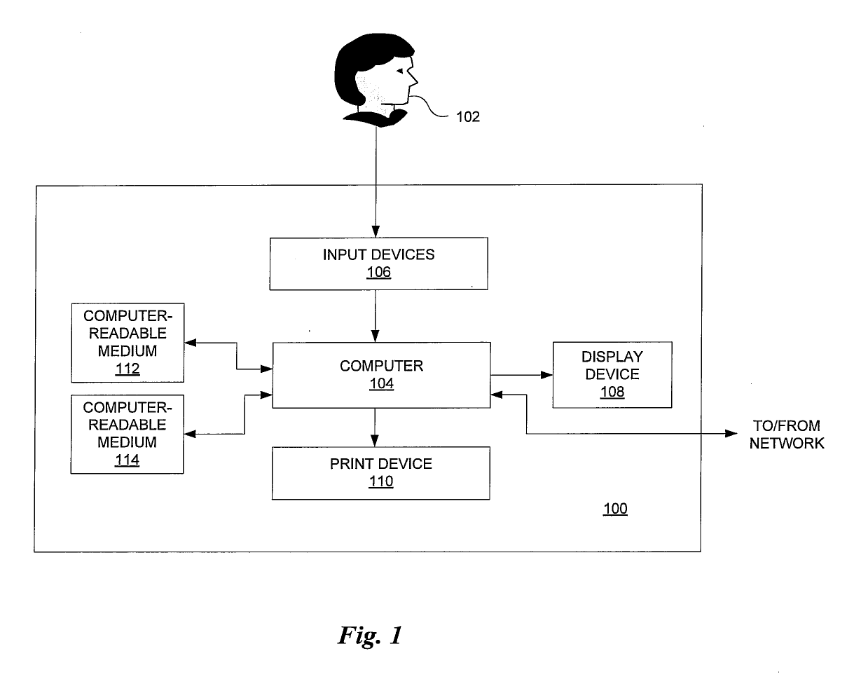

FIG. 1 is a block diagram of an information handling system, indicated generally at 100, according to the illustrative embodiment. In the example of FIG. 1, the system 100 operates in association with a human user 102. The system 100 is formed by various electronic circuitry components, including: (a) a general purpose computer 104, such as a workstation or server, for executing and otherwise processing instructions, and for performing additional operations (e.g., communicating information) in response thereto, as discussed further hereinbelow; (b) input devices 106 for receiving information from the user 102; (c) a display device 108 (e.g., a conventional flat panel monitor) for displaying information to the user 102; (d) a print device 110 (e.g., a conventional electronic printer or plotter) for printing visual images on paper; (e) a computer-readable medium (or apparatus) 112 (e.g., a hard disk drive or other nonvolatile storage device) for storing information; (f) a portable computer-readable medium (or apparatus) 114 (e.g., a removable flash memory card or CD-ROM) for storing information; and (g) various other electronic circuitry for performing other operations of the system 100.

Accordingly, in the example of FIG. 1, the computer 104 is connected to the input devices 106, the display device 108, the print device 110, the computer-readable medium 112, and the computer-readable medium 114, as shown in FIG. 1. Also, for example, the computer 104 includes a memory device (e.g., random access memory (“RAM”) device and/or read only memory (“ROM”) device) for storing information (e.g., instructions of software executed by the computer 104, and data processed by the computer 104 in response to such instructions).

In response to signals from the computer 104, the display device 108 displays visual images, which represent information, and the user 102 views such visual images. Moreover, the user 102 operates the input devices 106 to output information to the computer 104, and the computer 104 receives such information from the input devices 106. Also, in response to signals from the computer 104, the print device 110 prints visual images on paper, and the user 102 views such visual images.

The input devices 106 include, for example, a conventional electronic keyboard (or keypad) and a pointing device, such as a conventional electronic “mouse,” rollerball or light pen. The user 102 operates the keyboard (or keypad) to output alphanumeric text information to the computer 104, which receives such alphanumeric text information. The user 102 operates the pointing device to output cursor-control information to the computer 104, and the computer 104 receives such cursor-control information. The input devices 106 also include, for example, touch-sensitive circuitry of a liquid crystal display (“LCD”) device.

The computer 104 is coupled through a network to various other devices (not shown in FIG. 1). Through such network, the computer 104 outputs information (e.g., instructions, data, signals) to such devices, which receive and operate in response to such information. In one example, such information is specified by the user 102 to the computer 104 through the input devices 106. Also, through such network, such devices output information to the computer 104, which receives and operates in response to such information. In one example, such information is output by the computer 104 for display to the user 102 through the display device 108 and the print device 110, in response to command(s) from the user 102.

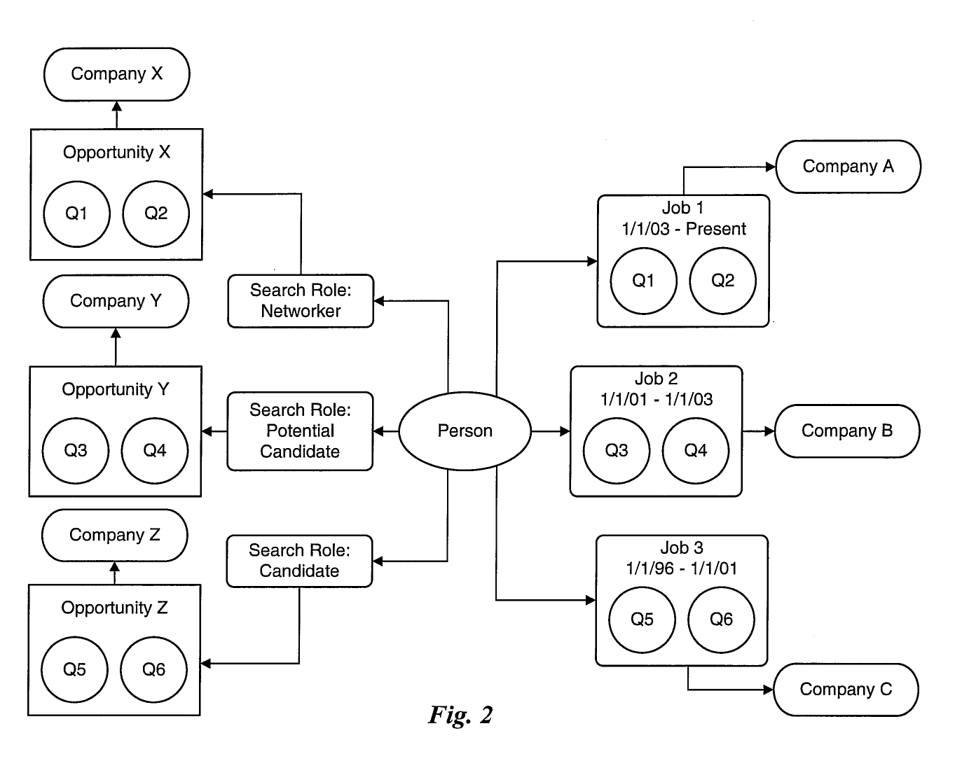

FIG. 2 is a first entity-relationship diagram of a database that is automatically stored and managed by the system 100, according to the illustrative embodiment. In response to information that the system 100 receives from the user 102, the system 100 automatically stores and manages the database on the computer-readable medium 112. Within the database, the system 100 automatically stores and manages information about relationships between various persons (e.g., employees, contractors), opportunities (e.g., employment opportunities, engagement opportunities), organizations (e.g., companies, which are employers or customers), and activities (e.g., jobs).

In the example of FIG. 2, the database includes information about relationships between: (a) a representative one of such persons; and (b) representative organizations, which are named as companies A, B, C, X, Y and Z. As shown in FIG. 2, the person has relationships with:

(a) the company A, because the person has existed (e.g., has been performing an activity named Job 1, as either an employee or contractor) in the company A since Jan. 1, 2003;

(b) the company B, because the person existed (e.g., performed an activity named Job 2, as either an employee or contractor) in the company B from Jan. 1, 2001 through Jan. 1, 2003; and

(c) the company C, because the person existed (e.g., performed an activity named

Job 3, as either an employee or contractor) in the company C from Jan. 1, 1996 through Jan. 1, 2001.

Also, the person has relationships with:

(a) the company X, because the person referred a candidate for an opportunity X at the company X;

(b) the company Y, because the person was a potential candidate for an opportunity Y at the company Y; and

(c) the company Z, because the person was an actual candidate for an opportunity Z at the company Z.

Accordingly: (a) in association with the opportunity X at the company X, the system 100 identifies the person as a “networker” in the database; (b) in association with the opportunity Y at the company Y, the system 100 identifies the person as a “potential candidate” in the database; and (c) in association with the opportunity Z at the company Z, the system 100 identifies the person as a “candidate” in the database.

Further, in the database, the system 100 stores information about one or more qualifications, which are specified to be satisfied by candidates for the various opportunities. For example, in the database, the system 100 stores information for recording the fact that: (a) the opportunity X specifies a qualification Q1 and a qualification Q2; (b) the opportunity Y specifies a qualification Q3 and a qualification Q4; (c) the opportunity Z specifies a qualification Q5 and a qualification Q6; (d) the qualification Q1 and the qualification Q2 are used for performing the Job 1; (e) the qualification Q3 and the qualification Q4 are used for performing the Job 2; and (f) the qualification Q5 and the qualification Q6 are used for performing the Job 3.

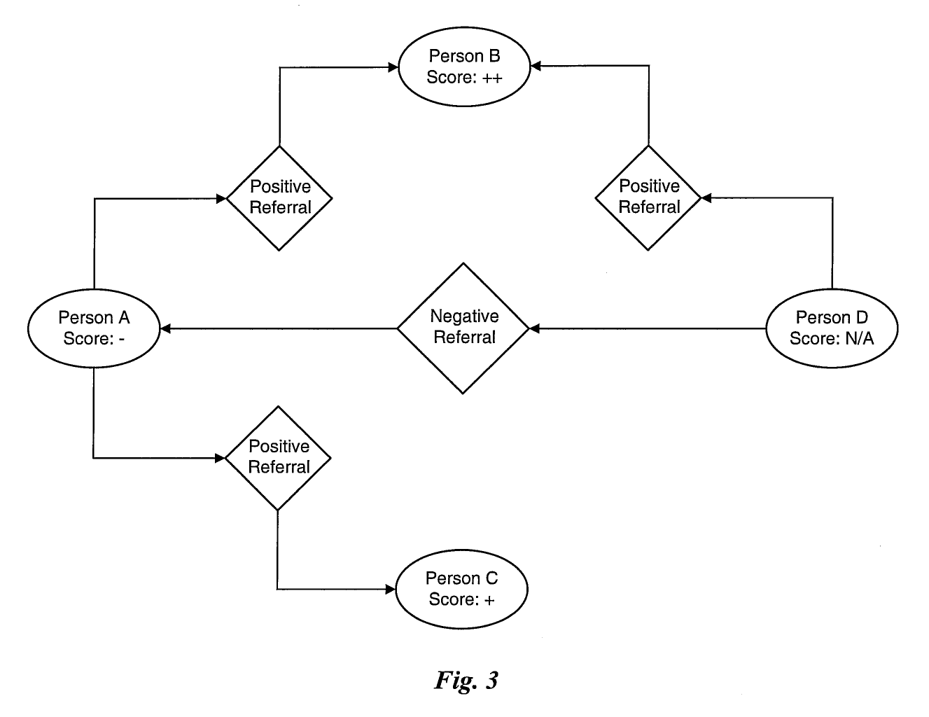

FIG. 3 is a second entity-relationship diagram of the database that is automatically stored and managed by the system 100, according to the illustrative embodiment. In the example of FIG. 3, the database includes information about relationships between representative persons. As shown in FIG. 3, a person A made: (a) a positive referral of a person B, so that the person A supported the person B as a candidate or potential candidate for an opportunity; and (b) a positive referral of a person C, so that the person A supported the person C as a candidate or potential candidate for an opportunity (e.g., the same opportunity, or a different opportunity). Further, a person D made: (a) a positive referral of the person B, so that the person D supported the person B as a candidate or potential candidate for an opportunity (e.g., the same opportunity, or a different opportunity); and (b) a negative referral of the person A, so that the person D declined to support the person A as a candidate or potential candidate for an opportunity (e.g., the same opportunity, or a different opportunity). Accordingly, in the example of FIG. 3, the persons A and D are networkers, because they have made such referrals of other persons.

Within the database, the system 100 automatically stores and manages information about such relationships between various persons, including their positive referrals and negative referrals of one another. In the example of FIG. 3, the system 100 automatically computes and stores various scores of such referrals, such as: (a) a score of (−), or (−1), for the person A, because the person A has been negatively referred by one person (i.e., the person D); (b) a score of (++), or (+2), for the person B, because the person B has been positively referred by two persons (i.e., the persons A and D); (c) a score of (+), or (+1), for the person C, because the person C has been positively referred by one person (i.e., the person A); and (d) a score of (N/A) for the person D, because the person D has been referred by nobody. In one example: (a) the person A is an existing coworker of the person B; (b) the person A is a former manager of the person C; and (c) the person D is a former interviewer of the person A.

In the illustrative embodiment, according to a suitable algorithm, the system 100 automatically computes and assigns weights to the various scores of such referrals, so that referrals by higher-scoring persons are weighted more (e.g., assigned greater weights) than referrals by lower-scoring persons. For example, if a particular person has been negatively referred by a number x of persons, yet also positively referred by the same number x of other persons, then the system 100 automatically computes and stores a score for the particular person, so that such score is: (a) zero (0) if all such referrals are weighted equally; (b) a positive variable number, as automatically computed by the system 100, if the x positively referring persons themselves are, on average, higher scoring than the x negatively referring persons; or (c) a negative variable number, as automatically computed by the system 100, if the x positively referring persons themselves are, on average, lower scoring than the x negatively referring persons.

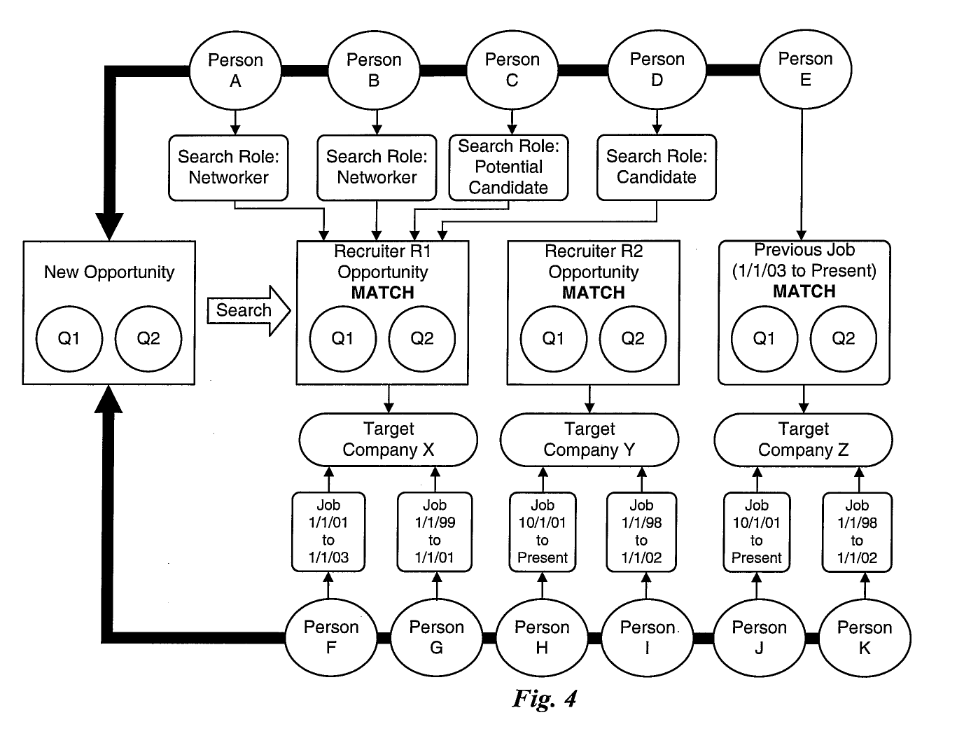

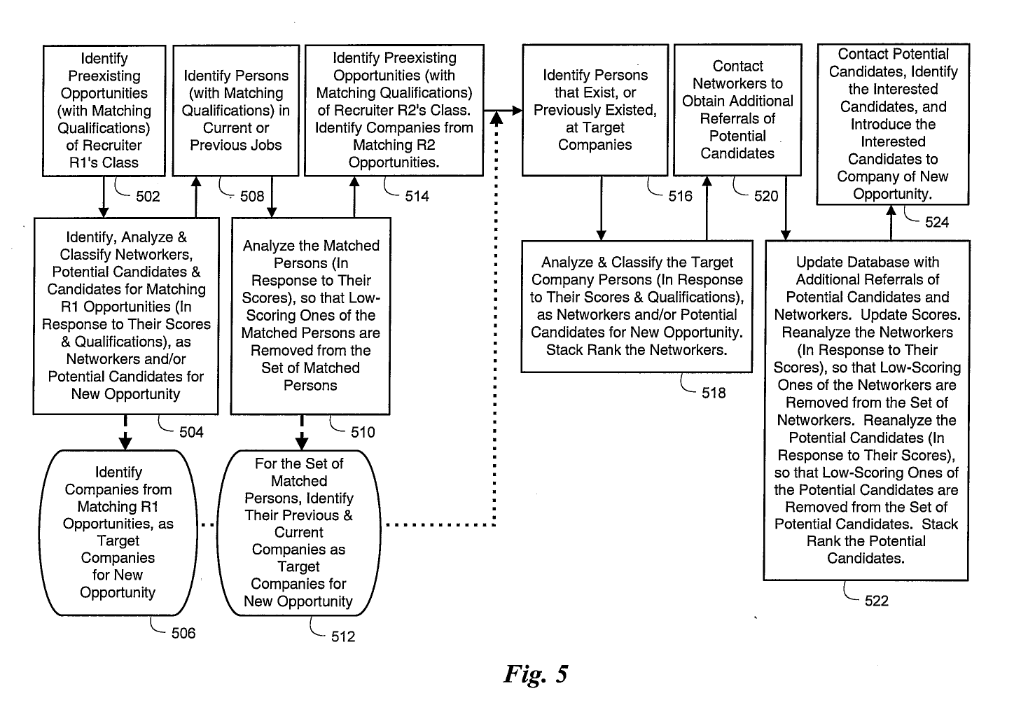

FIG. 4 is a data flow diagram of a method that is automatically performed by the system 100, according to the illustrative embodiment. FIG. 5 is a process flow diagram of such method.

In the examples of FIGS. 4 and 5, recruiters R1 and R2 are representative recruiters, and the system 100 receives and stores: (a) more information about the representative recruiter R1, and optionally additional recruiters in a same (or similar) class as the representative recruiter R1; and (b) less information about the representative recruiter R2, and optionally additional recruiters in a same (or similar) class as the representative recruiter R2. Accordingly, with respect to the amount of information received and stored by the system 100, some of the additional recruiters are more similar to the representative recruiter R1, while others of the additional recruiters are more similar to the representative recruiter R2.

In one example, a first group (e.g., a first class of recruiters) includes the representative recruiter R1 and additional representative recruiters R3, R4 and R5. As members of the first group, the recruiters R1, R3, R4 and R5 agree to collaborate by sharing with one another, and with the system 100: (a) full information about all of their respective opportunities (e.g., qualifications specified by such opportunities, and companies that have such opportunities); and (b) lists of their respective networkers, potential candidates, and candidates that have already been identified for various opportunities. In that manner, the recruiters R1, R3, R4 and R5 belong to a same (or similar) class as one another, and the recruiter R1 is a representative one of such recruiters.

In this example: (a) the representative recruiters R1 and R3 belong to a same organization as one another, so that the recruiters R1 and R3 both work “in-house” at a first organization (e.g., a first company) where first opportunities exist; (b) although the representative recruiters R1 and R4 belong to the same (or similar) class as one another, they belong to different organizations, so that the recruiter R1 works “in-house” at the first organization where the first opportunities exist, and the recruiter R4 works “in-house” at a second organization (e.g., a second company) where second opportunities exist; and (c) although the representative recruiters R1 and R5 belong to the same (or similar) class as one another, they belong to different organizations, so that the recruiter R1 works “in-house” at the first organization where the first opportunities exist, and the recruiter R5 works at a third organization (e.g., a third company) that has been engaged (e.g., on an “outsourced” basis) by the first organization to assist the first organization in recruiting candidates for the first opportunities. Optionally, the third organization may agree to be engaged by the second organization (in addition to the first organization) to likewise assist the second organization in recruiting candidates for the second opportunities. Similarly, the first organization and/or second organization may engage one or more additional organizations (e.g., a fourth company) to assist in recruiting candidates for the first opportunities and/or second opportunities, respectively.

For example, in connection with the representative recruiters R1, R3, R4 and R5, the system 100 receives and stores: (a) full information about all of their various opportunities; and (b) lists of networkers, potential candidates, and candidates that have already been identified for such opportunities. By comparison, in connection with the representative recruiter R2, the system 100 receives and stores less information, such as full or partial information about some or all of the representative recruiter R2's various opportunities. In one example, the system 100 receives and stores: (a) publicly available information, and confidential information, about the representative recruiters R1, R3, R4 and R5 and their activities; and (b) only publicly available information about the representative recruiter R2 and its activities.

Referring concurrently to FIGS. 4 and 5, the system 100 receives (e.g., from the user 102, such as the representative recruiter R1, or via the network) information about a new opportunity (also referred to herein as “current opportunity”) that specifies one or more qualifications, as shown by “New Opportunity” (with qualification Q1 and qualification Q2) in the example of FIG. 4. The company (where the new opportunity exists, such as the first organization of the recruiters R1 and R3) specifies such qualifications as being desired and/or required of candidates for the new opportunity. In one example, such qualifications include a candidate's: (a) skills; (b) length (e.g., number of years) of experience; (c) range of financial compensation (e.g., salary); (d) title(s) of position(s) currently and/or previously held; (e) geographic location; and/or (f) personality traits.

In response to the new opportunity, the system 100 automatically performs various searches of the database, in order to identify one or more persons as networkers, potential candidates, and candidates for the new opportunity.

Accordingly, in the illustrative embodiment, the system 100 automatically:

(a) at a step 502, searches the database to identify: (i) which, if any, of the recruiter R1's preexisting opportunities (which may, or may not, still exist) have specified qualifications that substantially match (e.g., are the same, or substantially overlap with) the new opportunity's specified qualifications, as shown by “Recruiter R1 Opportunity Match” in the example of FIG. 4; and (ii) likewise, to the extent that additional recruiters belong to the same (or similar) class as the representative recruiter R1, which, if any, of such additional recruiters' preexisting opportunities (which may, or may not, still exist) have specified qualifications that substantially match the new opportunity's specified qualifications (so that the substantially matching ones of the recruiter R1's preexisting opportunities and the substantially matching ones of such additional recruiters' preexisting opportunities, which are so identified at the step 502, are referenced collectively as “Matching R1 Opportunities”);

(b) at a step 504, identifies networkers, potential candidates, and candidates that have already been identified (in the database) for the Matching R1 Opportunities (“identified persons”), as shown by persons A, B, C and D in the example of FIG. 4;

(b) at the step 504, analyzes the identified persons, in response to their scores, so that the system 100 automatically removes low-scoring ones of the identified persons from the set of identified persons that remains (“remaining identified persons”), according to a threshold specified by the user 102; and

(c) at the step 504, classifies the remaining identified persons, in response to their scores and qualifications (e.g., weighted combinations of their scores and qualifications), as networkers or potential candidates for the new opportunity, so that: (i) certain ones of the remaining identified persons, whose qualifications fail to substantially match the new opportunity's specified qualifications, are classified as networkers, instead of being classified as potential candidates; and (ii) other ones of the remaining identified persons, whose qualifications substantially match the new opportunity's specified qualifications, are classified as potential candidates, and as networkers; and

(d) at a step 506, identifies companies where the Matching R1 Opportunities exist or previously existed, so that such companies are target companies (where other networkers, potential candidates, and candidates may currently exist) for the new opportunity, as shown by the target company X in the example of FIG. 4.

Also, the system 100 automatically:

(a) at a step 508, searches the database to identify which, if any, additional persons have qualifications that substantially match the new opportunity's specified qualifications (“matched persons”), as shown by a person E and “Previous Job (Jan. 1, 2003 to Present) Match” in the example of FIG. 4;

(b) at a step 510, analyzes the matched persons, in response to their scores, so that the system 100 automatically removes low-scoring ones of the matched persons from the set of matched persons that remains (“remaining matched persons”), according to a threshold specified by the user 102; and

(c) at a step 512, identifies companies where the remaining matched persons exist or previously existed, so that such companies are target companies (where other networkers, potential candidates, and candidates may currently exist) for the new opportunity, as shown by the target company Z in the example of FIG. 4.

Further, the system 100 automatically:

(a) at a step 514, searches the database to identify: (i) which, if any, of the recruiter R2's preexisting opportunities (which may, or may not, still exist) have specified qualifications that substantially match (e.g., are the same, or substantially overlap with) the new opportunity's specified qualifications, as shown by “Recruiter R2 Opportunity Match” in the example of FIG. 4; and (ii) likewise, to the extent that additional recruiters belong to the same (or similar) class as the representative recruiter R2, which, if any, of such additional recruiters' preexisting opportunities (which may, or may not, still exist) have specified qualifications that substantially match the new opportunity's specified qualifications (so that the substantially matching ones of the recruiter R2's preexisting opportunities and the substantially matching ones of such additional recruiters' preexisting opportunities, which are so identified at the step 514, are referenced collectively as “Matching R2 Opportunities”); and

(b) at the step 514, identifies companies where the Matching R2 Opportunities exist or previously existed, as shown by the target company Y in the example of FIG. 4, so that such companies are target companies (where other networkers, potential candidates, and candidates may currently exist) for the new opportunity.

With continued reference to FIGS. 4 and 5, the system 100 automatically:

(a) at a step 516, searches the database to identify which, if any, additional persons exist (or previously existed) in the target companies (“target persons”), as shown by persons F, G, H, I, J and K in the example of FIG. 4; and

(b) at a step 518, analyzes the target persons, in response to their scores, so that the system 100 automatically removes low-scoring ones of the target persons from the set of target persons that remains (“remaining target persons”), according to a threshold specified by the user 102;

(b) at the step 518, classifies the remaining target persons, in response to their scores and qualifications (e.g., weighted combinations of their scores and qualifications), as networkers or potential candidates for the new opportunity, so that: (i) certain ones of the remaining target persons, whose qualifications fail to substantially match the new opportunity's specified qualifications, are classified as networkers, instead of being classified as potential candidates; and (ii) other ones of the remaining target persons, whose qualifications substantially match the new opportunity's specified qualifications, are classified as potential candidates, and as networkers; and

(c) at the step 518, stack ranks the networkers, in response to their scores, so that high-scoring ones of the networkers are ranked higher, and low-scoring ones of the networkers are ranked lower.

To the user 102, the system 100 automatically outputs a list (including names and contact information) of all networkers, which were stack ranked at the steps discussed above. By reviewing the stack-ranked list of networkers, the user 102 is equipped to suitably prioritize its time in contacting one or more of the networkers. In that manner, with such list, the user 102 is equipped to contact the networkers at a step 520, in order to ask them for additional referrals of potential candidates (and networkers) for the new opportunity. For example, such additional referrals include: (a) referrals of additional potential candidates; (b) referrals of additional networkers; and (c) positive, and/or negative, referrals of potential candidates (and networkers) that were already identified and classified at the steps discussed above.

The user 102 suitably operates the input devices 106, in order to update the database of the system 100, so that the database includes such additional referrals of potential candidates (and networkers). At a step 522, in response to the updated database, the system 100 automatically calculates and/or updates scores of potential candidates (and networkers), including: (a) the additional potential candidates; (b) the additional networkers; (c) the potential candidates that were already identified and classified at the steps discussed above; and (d) the networkers that were already identified and classified at the steps discussed above.

With continued reference to FIGS. 4 and 5, the system 100 automatically:

(a) at the step 522, reanalyzes the networkers, in response to their scores (resulting from such calculating and/or updating), so that the system 100 automatically removes low-scoring ones of the networkers from the set of networkers that remains (“remaining networkers”), according to a threshold specified by the user 102;

(b) at the step 522, reanalyzes the potential candidates, in response to their scores

(resulting from such calculating and/or updating), so that the system 100 automatically removes low-scoring ones of the potential candidates from the set of potential candidates that remains

(“remaining potential candidates”), according to a threshold specified by the user 102; and

(c) at the step 522, stack ranks the remaining potential candidates, in response to their scores and qualifications (e.g., weighted combinations of their scores and qualifications), so that high-scoring/well-qualified ones of the remaining potential candidates are ranked higher, and low-scoring/barely-qualified ones of the remaining potential candidates are ranked lower.

To the user 102, the system 100 automatically outputs a list (including names and contact information) of the remaining potential candidates, which were stack ranked at the steps discussed above. By reviewing the stack-ranked list of remaining potential candidates, the user 102 is equipped to suitably prioritize its time in contacting one or more of the remaining potential candidates. In that manner, with such list, the user 102 is equipped to contact the potential candidates at a step 524, in order to identify ones that are interested in the new opportunity. After identifying such interested candidates, the user 102 introduces them to the company that has the new opportunity, at the step 524.

Based on such contacts (at the step 524) with the potential candidates and the interested candidates, and based on further contacts (at the step 520) with the networkers: (a) the user 102 suitably operates the input devices 106, in order to update the database of the system 100, so that the database includes additional referrals of potential candidates (and networkers); and (b) in response to the updated database, the system 100 automatically repeats the step 522. In that manner, the system 100 assists the user 102 by automatically identifying and updating lists of networkers and potential candidates for the new opportunity, and by outputting such lists to the user 102.

Referring again to FIG. 1, the computer 104 and the computer-readable medium 114 are structurally and functionally interrelated with one another, as described further hereinbelow. In that regard, the computer-readable medium 114 is a representative one of the computer-readable media of the system 100 (including, but not limited to, the computer-readable medium 112). The computer-readable medium 114 stores (or encodes, or records, or embodies) functional descriptive material (including, but not limited to, software and data structures). Such functional descriptive material imparts functionality when encoded on the computer-readable medium 114. Also, such functional descriptive material is structurally and functionally interrelated to the computer-readable medium 114.

Within such functional descriptive material, data structures define structural and functional interrelationships between such data structures and the computer-readable medium 114 (and other aspects of the computer 104 and the system 100). Such interrelationships permit the data structures' functionality to be realized. Also, within such functional descriptive material, software (also referred to as computer programs or applications) defines structural and functional interrelationships between such software and the computer-readable medium 114 (and other aspects of the computer 104 and the system 100). Such interrelationships permit the software's functionality to be realized.

For example, the computer 104 reads (or accesses, or copies) such functional descriptive material from the computer-readable medium 114 into the memory device of the computer 104, and the computer 104 performs its operations (as described elsewhere herein) in response to such material, which is stored in the memory device of the computer 104. More particularly, the computer 104 performs the operation of processing software (which is stored, encoded, recorded or embodied on a computer-readable medium) for causing the computer 104 to perform additional operations (as described elsewhere herein). Accordingly, such functional descriptive material exhibits a functional interrelationship with the way in which the computer 104 executes its processes and performs its operations.

Further, the computer-readable media of the system 100 are apparatus from which the software is accessible by the computer 104, and the software is processable by the computer 104 for causing the computer 104 to perform such additional operations. In addition to reading such functional descriptive material from the computer-readable medium 114, the computer 104 is capable of reading such functional descriptive material from (or through) a network, which is also a computer-readable medium (or apparatus) of the system 100. Moreover, the memory device of the computer 104 is itself a computer-readable medium (or apparatus) of the system 100.

Although illustrative embodiments have been shown and described, a wide range of modification, change and substitution is contemplated in the foregoing disclosure. In some instances, various features of the embodiments may be used without a corresponding use of other features.

What is claimed is:

1. A method performed by an information handling system, the method comprising:
in a database, storing information about persons and their qualifications;
in response to information about a current opportunity that specifies at least one qualification, searching the database to identify at least one of the following: first persons having qualifications that substantially match the current opportunity's specified qualification; and preexisting opportunities that specify one or more qualifications that substantially match the current opportunity's specified qualification;
searching the database to identify target companies that satisfy at least one of the following conditions: the target company is where at least one of the first persons exists; the target company is where at least one of the first persons previously existed; the target company is where at least one of the preexisting opportunities exists; and the target company is where at least one of the preexisting opportunities previously existed;
searching the database to identify second persons that satisfy at least one of the following conditions: the second person exists in at least one of the target companies; and the second person previously existed in at least one of the target companies; and
outputting a list of the second persons to a human user, so that the human user is equipped to contact the second persons.

2. The method of claim 1, wherein the outputting comprises:
outputting the list of the second persons to the human user, so that the human user is equipped to contact the second persons, in order to ask the second persons for referrals of referred persons that comprise at least one of the following: one or more of the first persons; one or more of the second persons having qualifications that substantially match the current opportunity's specified qualification; and one or more third persons having qualifications that substantially match the current opportunity's specified qualification.

3. The method of claim 2, and comprising:
in response to the referrals, outputting a list of the referred persons to the human user, so that the human user is equipped to contact the referred persons, in order to ask the referred persons about interest in the current opportunity.

4. The method of claim 3, and comprising:
stack ranking the list of the referred persons, in response to scores of the referrals of the referred persons, so that the list of the referred persons is a stack-ranked list.

5. The method of claim 4, wherein the stack ranking comprises:
stack ranking the list of the referred persons, in response to a weighted combination of the following, so that the list of the referred persons is a stack-ranked list: the scores of the referrals of the referred persons; and an extent to which the referred persons have qualifications that substantially match the current opportunity's specified qualification.

6. The method of claim 3, and comprising:
in response to scores of the referrals of the referred persons, removing low-scoring ones of the referred persons from the list of the referred persons, before outputting the list of the referred persons to the human user.

7. The method of claim 3, and comprising:
weighting scores of the referrals of the referred persons, according to scores of the second persons who provided the referrals of the referred persons;
stack ranking the list of the referred persons, in response to a weighted combination of the following, so that the list of the referred persons is a stack-ranked list: the scores of the referrals of the referred persons; and an extent to which the referred persons have qualifications that substantially match the current opportunity's specified qualification; and
in response to the scores of the referrals of the referred persons, removing low-scoring ones of the referred persons from the list of the referred persons, before outputting the list of the referred persons to the human user.

8. The method of claim 1, and comprising:
stack ranking the list of the second persons, in response to scores of referrals of the second persons, so that the list of the second persons is a stack-ranked list.

9. The method of claim 1, and comprising:
in response to scores of referrals of the second persons, removing low-scoring ones of the second persons from the list of the second persons, before outputting the list of the second persons to the human user.

10. The method of claim 1, and comprising:
stack ranking the list of the second persons, in response to scores of referrals of the second persons, so that the list of the second persons is a stack-ranked list; and
in response to the scores of the referrals of the second persons, removing low-scoring ones of the second persons from the list of the second persons, before outputting the list of the second persons to the human user.

11. An information handling system, comprising:
a database for storing information about persons and their qualifications; and
a computer for:
in response to information about a current opportunity that specifies at least one qualification, searching the database to identify at least one of the following: first persons having qualifications that substantially match the current opportunity's specified qualification; and preexisting opportunities that specify one or more qualifications that substantially match the current opportunity's specified qualification;
searching the database to identify target companies that satisfy at least one of the following conditions: the target company is where at least one of the first persons exists; the target company is where at least one of the first persons previously existed; the target company is where at least one of the preexisting opportunities exists; and the target company is where at least one of the preexisting opportunities previously existed;
searching the database to identify second persons that satisfy at least one of the following conditions: the second person exists in at least one of the target companies; and the second person previously existed in at least one of the target companies; and
outputting a list of the second persons to a human user, so that the human user is equipped to contact the second persons.

12. The system of claim 11, wherein the computer is for:
outputting the list of the second persons to the human user, so that the human user is equipped to contact the second persons, in order to ask the second persons for referrals of referred persons that comprise at least one of the following: one or more of the first persons; one or more of the second persons having qualifications that substantially match the current opportunity's specified qualification; and one or more third persons having qualifications that substantially match the current opportunity's specified qualification.

13. The system of claim 12, wherein the computer is for:
in response to the referrals, outputting a list of the referred persons to the human user, so that the human user is equipped to contact the referred persons, in order to ask the referred persons about interest in the current opportunity.

14. The system of claim 13, wherein the computer is for:
stack ranking the list of the referred persons, in response to scores of the referrals of the referred persons, so that the list of the referred persons is a stack-ranked list.

15. The system of claim 14, wherein the computer is for:
stack ranking the list of the referred persons, in response to a weighted combination of the following, so that the list of the referred persons is a stack-ranked list: the scores of the referrals of the referred persons; and an extent to which the referred persons have qualifications that substantially match the current opportunity's specified qualification.

16. The system of claim 13, wherein the computer is for:
in response to scores of the referrals of the referred persons, removing low-scoring ones of the referred persons from the list of the referred persons, before outputting the list of the referred persons to the human user.

17. The system of claim 13, wherein the computer is for:
weighting scores of the referrals of the referred persons, according to scores of the second persons who provided the referrals of the referred persons;
stack ranking the list of the referred persons, in response to a weighted combination of the following, so that the list of the referred persons is a stack-ranked list: the scores of the referrals of the referred persons; and an extent to which the referred persons have qualifications that substantially match the current opportunity's specified qualification; and
in response to the scores of the referrals of the referred persons, removing low-scoring ones of the referred persons from the list of the referred persons, before outputting the list of the referred persons to the human user.

18. The system of claim 11, wherein the computer is for:
stack ranking the list of the second persons, in response to scores of referrals of the second persons, so that the list of the second persons is a stack-ranked list.

19. The system of claim 11, wherein the computer is for:
in response to scores of referrals of the second persons, removing low-scoring ones of the second persons from the list of the second persons, before outputting the list of the second persons to the human user.

20. The system of claim 11, wherein the computer is for:
stack ranking the list of the second persons, in response to scores of referrals of the second persons, so that the list of the second persons is a stack-ranked list; and
in response to the scores of the referrals of the second persons, removing low-scoring ones of the second persons from the list of the second persons, before outputting the list of the second persons to the human user.
